(19) United States
(12) Patent Application Publication
(10) Pub. No.: US 2022/0135090 A1
(43) Pub. Date: May 5, 2022

(54) PRESSURE REGULATING APPARATUS IN VEHICLE AND REGULATING METHOD

(71) Applicant: CRRC QINGDAO SIFANG CO., LTD., Qingdao, Shandong (CN)

(72) Inventors: Zhenhuan LIU, Qingdao, Shandong (CN); Xiaozhou LIU, Qingdao, Shandong (CN); Shudian LI, Qingdao, Shandong (CN); Guidong TAO, Qingdao, Shandong (CN); Jiangchun LI, Qingdao, Shandong (CN); Haoli JIANG, Qingdao, Shandong (CN); Xiaoyan YANG, Qingdao, Shandong (CN); Xiugang LI, Qingdao, Shandong (CN); Meng XU, Qingdao, Shandong (CN); Yangyang CHEN, Qingdao, Shandong (CN)

(73) Assignee: CRRC QINGDAO SIFANG CO., LTD., Qingdao, Shandong (CN)

(21) Appl. No.: 17/435,050

(22) PCT Filed: Sep. 2, 2019
(86) PCT No.: PCT/CN2019/104021

§ 371 Date: Aug. 31, 2021

(30) Foreign Application Priority Data
Mar. 1, 2019 (CN) 201910153959.1

(51) Int. Cl. B61D 27/00

(52) U.S. Cl. CPC B61D 27/0009; B61D 27/009

(57) ABSTRACT

Provided is a pressure regulating method in a vehicle, comprising the following steps: S1, detecting a pressure value P in a vehicle compartment; and S2, regulating and correcting the angle of a waste exhaust valve by a control apparatus according to a starting command until target requirements are met. A pressure regulating apparatus in a vehicle for realizing the pressure regulating method is further comprised. The pressure in a vehicle compartment is regulated by regulating the angle of an exhaust valve, so that the pressure in the vehicle compartment is always controlled within a reasonable range, and the problem of pressure change in a vehicle during the operation of the vehicle is solved; meanwhile, comfort of sitting in the vehicle is achieved, and the cost of testing is lowered.

### TECHNICAL FIELD

The present application relates to the technical field of pressure regulating, and particularly to an apparatus for regulating a pressure in a vehicle and a method thereof.

### BACKGROUND

The pressure value in a rail vehicle is one of comfort indexes. An air-conditioning system of existing rail vehicles generally includes an air supply system and an air exhaust system. The ventilation fan in the air-conditioning unit draws in the fresh air outside the vehicle and the returned air inside the vehicle, and blows them into the vehicle after cooling or heating. The air exhaust system discharges the exhaust air outside the vehicle. The volume of fresh air drawn into the air-conditioning unit can be regulated by a fresh air valve and the volume of exhaust air blown out the vehicle can be regulated by an exhaust air valve.

The differential between the volume of fresh air and the volume of exhaust air is a main factor affecting the pressure in the vehicle. In practice, the pressure in the vehicle is regulated through controlling the volume of fresh air drawn in by the air supply system and the volume of exhaust air blown out by the exhaust air apparatus. The air volume could be controlled in terms of different types of fans, the fresh air valve of the air-conditioning unit and the exhaust air valve of the exhaust air apparatus.

For the air-conditioning system of a brand new project, types of the ventilation fan and the exhaust air fan are determined through experiments. Generally, the air-conditioning system sets the volume of fresh air as three levels: high, medium and low. And the angle A of the fresh air valve is also set as three corresponding levels. To maintain the pressure in the vehicle within the regulated range, the angle B of the exhaust air valve is set as three levels corresponding to the levels of the angle A of the fresh air valve. During the operation of the air-conditioning system, the angle A of the fresh air valve and the angle B of the exhaust air valve are controlled by the air-conditioning controller. The relationships between them are as follows:

Angle A1 of the fresh air valve corresponds to a volume 1 of fresh air→Angle B1 of the exhaust air valve;

Angle A2 of a fresh air valve corresponds to a volume 2 of fresh air→Angle B2 of the exhaust air valve; and

Angle A3 of a fresh air valve corresponds to a volume 3 of fresh air→Angle B3 of the exhaust air valve

If the structure is modified based on the existing vehicle type, changes of air ducts may possibly result in pressure changes in the vehicle. Long-term operation of air ducts and filters increases the resistance in the air ducts, and the performance of the fan also changes due to long-term operation. These result in pressure changes in the vehicle. To regulate the pressure in the vehicle within a predetermined range, simultaneous testing is made for matching angles of the fresh air valve and the exhaust air valve.

For a brand new project, it is usual by test to match angles of the fresh air valve and the exhaust air valve. Also, in some design projects, slight modification in air ducts results in pressure changes in the vehicle, the change of performance of the fan and increased resistance in the air ducts also affect the pressure in the vehicle. It is not economical to re-implement considerable tests to ensure that the pressure in the vehicle meets the requirements.

### SUMMARY OF THE INVENTION

The present application provides a method for regulating a pressure in a vehicle and an apparatus thereof. The method and apparatus can control the pressure in the vehicle within an appropriate range in case of pressure change due to resistance in the air duct, the change of performance of the fan or changes in vehicle structure. Also, it can avoid lots of experiments and stimulations, thereby reducing large cost of experiment.

As for the object mentioned above, the present application provides the following technical solutions.

A method for regulating a pressure in a vehicle comprises the following steps:

In step S1, detecting a pressure P in a compartment of the vehicle; and

In step S2, regulating, by a control apparatus, an angle of an exhaust air valve in response to a starting command, until a target requirement is met.

The starting command is to instruct the control apparatus to determine whether the pressure P in the compartment exceeds a set pressure range Ps±ΔP, and to automatically regulate the angle of the exhaust air valve in a set logic if the pressure exceeds the set pressure range.

During each regulation cycle, after an air-conditioning system is initially powered on, the control apparatus automatically determines whether the pressure P in the compartment exceeds the set pressure range Ps±ΔP and automatically regulates the angle of the exhaust air valve.

The method further comprises: a manual operation of determining whether the angle regulation should continue if the control apparatus determines that the pressure P in the compartment exceeds the set pressure range Ps±ΔP.

The set logic is that,

if the detected pressure P in the compartment is higher than the set pressure range Ps+ΔP, the angle of the exhaust air valve is controlled to increase by once or more times control until the target requirement is met; and

if the detected pressure P in the compartment is lower than the set pressure range Ps−ΔP, the angle of the exhaust air valve is controlled to decrease by once or more times control until the target requirement is met;

wherein the target requirement is to regulate the pressure P in the compartment to fall within the set pressure range Ps±ΔP.

The starting command is to manually activate a starting switch which functioning as “increase” or “decrease”, and the control apparatus controls the exhaust air valve to correspondingly increase or decrease a set angle in response to each manual activation.

The target requirement is the number of manually activating the starting switch.

A time interval is set between two adjacent regulations.

The control apparatus includes an air-conditioning system controller or a controller for an exhaust air apparatus.

Another embodiment of the present application provides an apparatus for pressure regulating a pressure in a vehicle. The apparatus includes a pressure detection apparatus and a control apparatus.

The pressure detection apparatus is configured to detect in real time a pressure P in a compartment of the vehicle;

The control apparatus is configured to regulate an angle of an exhaust air valve in response to a starting command until a target requirement is met.

The method for regulating a pressure in a vehicle and an apparatus thereof according to embodiment of the present application address the issue of pressure changes in the vehicle due to the change of performance of the fan or increased resistance in the air duct during operation of the vehicle. Also, the method addresses the issue of pressure changes in the vehicle due to changes in vehicle structure, such as in air ducts, by modification on the existing platform. With this method, the pressure in the compartment is constantly controlled within an appropriate range by regulating the angle of the exhaust air valve 3, providing a good ride comfort within the vehicle. Also, the method can avoid experiments and stimulations for regulating the pressure in the vehicle when modifying design on the existing platform, thereby reducing large cost of experiments and enlarging the scope of applications of air-conditioning system platform functioning as fundamental products.

### BRIEF DESCRIPTION OF THE DRAWINGS

FIG. 1 is a flow chart of regulating a pressure in a vehicle according to a first embodiment of the present invention;

FIG. 2 is a flow chart of regulating a pressure in a vehicle according to a second embodiment of the present invention;

FIG. 3 is a flow chart of regulating a pressure in a vehicle according to a third embodiment of the present invention;

FIG. 4 is a flow chart of regulating a pressure in a vehicle according to a fourth embodiment of the present invention, and

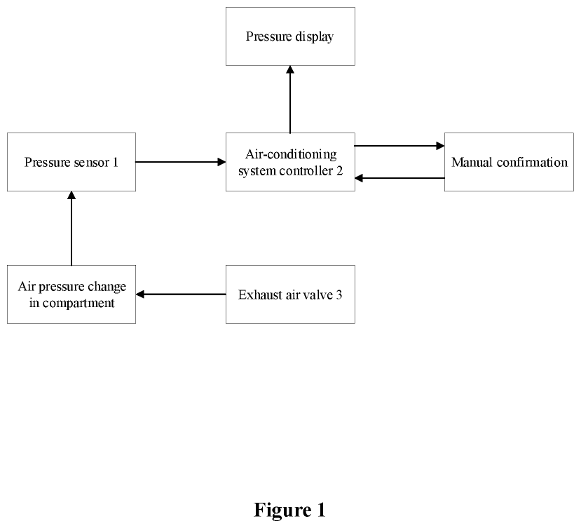

In FIG. 1 to FIG. 4, a pressure sensor 1, an air-conditioning system controller 2, an exhaust air valve 3, and an exhaust air apparatus controller 4 are shown.

### DETAILED DESCRIPTION OF THE INVENTION

Hereinafter, the present invention is described in detail in conjunction with the accompanying drawings and the embodiments.

### A First Embodiment

As shown in FIG. 1, the present application provides an apparatus for regulating a pressure in a vehicle. The apparatus for regulating a pressure includes a pressure detection apparatus and a control apparatus.

The pressure detection apparatus may be a pressure sensor 1 or a differential pressure sensor, which is installed inside the compartment to detect a pressure P in the compartment in real time and to send data of the detected pressure P to the control apparatus in real time. At least one pressure sensor 1 or differential pressure sensor is installed in each compartment, for monitoring pressure changes in each compartment in real time. The pressure sensor 1 only collects data of pressure in the vehicle, thus it can be installed anywhere in the compartment, e.g., inside the control cabinet which is on the roof of the compartment.

The pressure sensor 1 detects any pressure change in the running vehicle. The pressure change in the vehicle may be caused by changed performance of the fan or increased resistance in air ducts (which may be caused by blocked filters passing the turn air or increasingly roughened surface of the air ducts). The pressure sensor 1 can also detect any pressure change in real time in the vehicle caused by modification to vehicle structures such as air ducts based on existing design platform.

The control apparatus is applied for regulating the angle of an exhaust air valve 3 in response to a starting command until a target requirement is met. It regulates the angle of the exhaust air valve 3 to regulate the volume of exhaust air so as to control the differential between volumes of fresh air and exhaust air, thereby regulating the pressure in the compartment. Alternatively, the pressure in the compartment may be regulated by regulating the angle of the fresh air valve.

The pressure sensor 1 is connected to the control apparatus via a control line. Each compartment is equipped with the pressure sensor 1, and for simplicity, the air-conditioning system controller 2 installed in each compartment functions as the control apparatus in this embodiment. One or more pressure sensors 1 installed in the compartment are all connected to the air-conditioning system controller 2 in the corresponding compartment. The air-conditioning system controller 2 receives and processes data of the pressure collected by the pressure sensor 1, calculates and analyzes the data , and controls the regulation of the angle of the exhaust air valve 3.

A method for regulating a pressure in a vehicle is described in detail as follows, which comprises the following steps.

In step S1, a pressure P in the compartment is detected.

At least one pressure sensor 1 installed in each compartment of the vehicle detects any pressure change in the compartment and transmits in real time data of collected pressure to the air-conditioning system controller 2 of the compartment.

In step S2, the control apparatus regulates an angle of an exhaust air valve 3 in response to a starting command, until a target requirement is met.

The starting command is to instruct the control apparatus to determine whether the pressure P in the compartment exceeds a set pressure range Ps±ΔP, and to instruct the control apparatus to automatically regulate the angle of the exhaust air valve 3 in a set logic if the pressure in the compartment exceeds the set pressure range. The target requirement is to regulate the pressure P in the compartment to fall within the set pressure range Ps±ΔP.

To improve the accuracy of control, a regulation cycle is set. During each regulation cycle, after the air-conditioning system is initially powered on, the control apparatus automatically determines whether the pressure P in the compartment exceeds the set pressure range Ps±ΔP and automatically regulates the angle of the exhaust air valve 3 accordingly. In this embodiment, the regulation cycle is preferably set as one day, that is, the angle of the exhaust air valve 3 is regulated once within one day. The regulated angle of the exhaust air valve 3 is saved into the air-conditioning system controller 2. The air-conditioning system when being powered on again works with reference to the regulated angle.

The control apparatus also automatically determines whether the pressure P in the compartment exceeds the set pressure range Ps±ΔP if the structure of air ducts is modified and automatically regulates the angle of the exhaust air valve 3 accordingly. The regulated angle of the exhaust air valve 3 is saved into the air-conditioning system controller 2. The air-conditioning system when being powered on again works with reference to the regulated angle.

In the embodiment, preferably, the method further comprises a manual operation of determining whether the angle regulation should continue if the control apparatus determines that the pressure P in the compartment exceeds the set pressure range Ps±ΔP. A dialog box pops up on the display of the air-conditioning system controller 2. The user clicks “agree to regulate” in the dialog box, and accordingly angle regulation is made to the exhaust air valve 3. Admittedly, the process of clicking “agree to regulate” in practice may be canceled, and the whole process of angle regulation is finished automatically by the air-conditioning system controller 2.

The set logic of regulating the angle of the exhaust air valve 3 is described as follows. If the detected pressure P in the compartment is higher than the set pressure range Ps+ΔP, the angle of the exhaust air valve 3 is controlled to increase by once or more times control until the target requirement is met. If the detected pressure P in the compartment is lower than the set pressure range Ps−ΔP, the angle of the exhaust air valve 3 is controlled to decrease by once or more times control until the target requirement is met.

A set angle for each increase or decrease is preferably 1 degree. After each regulation, the pressure P in the compartment is detected. If the pressure P in the compartment does not reach the set pressure range, a second regulation is performed after a set time interval until the target requirement is met. The time interval between two adjacent regulations is preferably set as 30 seconds.

Step S2 comprises the steps as described below.

In step S21, after the vehicle is initially powered on, the air-conditioner works in a centralized control and automatic operation mode (in non-manual mode or in non-emergency ventilation mode), the air-conditioning system controller 2 determines whether the current pressure P in the compartment falls within the set pressure range Ps±ΔP based on data from the pressure sensor 1.

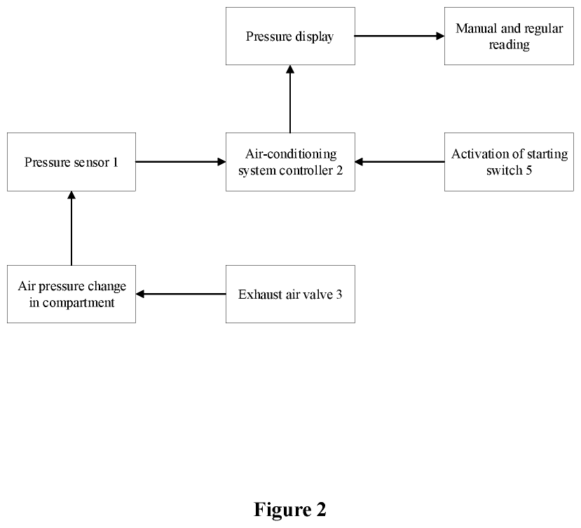

In step S22, if the pressure P in the compartment is higher than the set pressure range Ps+ΔP, the air-conditioning system controller 2 pops up a notification dialog box, in which the user clicks “agree to regulate”, the air-conditioning system controller 2 regulates the angle of the exhaust air valve 3. As shown in FIG. 2, this regulation process is described as follows.

The angle of the exhaust air valve 3 increases by 1 degree. After a set time interval (30 seconds), the regulation process ends if the pressure P in the compartment meets the requirement. Otherwise, the angle of the exhaust air valve 3 increases by 1 degree and the process waits for another 30 seconds. The above sub-processes are repeated until the requirement is met.

In step S23, if the pressure P in the compartment is lower than the set pressure range Ps−ΔP, the air-conditioning system controller 2 pops up a notification dialog box, in which the user clicks “agree to regulate”, the air-conditioning system controller 2 regulates the angle of the exhaust air valve 3. As shown in FIG. 2, this regulation process is described as follows.

The angle of the exhaust air valve 3 decreases by 1 degree. After a set time interval (30 seconds), the regulation process ends if the pressure P in the compartment meets the requirement. Otherwise, the angle of the exhaust air valve 3 decreases by 1 degree and the process waits for another 30 seconds. The above sub-processes are repeated, until the requirement is met.

In step S23, the regulated angle of the exhaust air valve 3 is updated and saved into the air-conditioning system controller 2. The air-conditioning system when being powered on again works with reference to the regulated angle.

The regulating method addresses the issue of pressure changes in the vehicle due to the change of performance of the fan or increased resistance in the air duct during operation of the vehicle. Also, the method addresses the issue of pressure changes in the vehicle due to changes in vehicle structure, such as in air ducts, by modification on the existing platform. With this method, the pressure in the compartment is constantly controlled within an appropriate range by regulating the angle of the exhaust air valve 3, providing a good ride comfort within the vehicle. Also, the method can avoid experiments and stimulations for regulating the pressure in the vehicle when modifying design on the existing platform, thereby reducing large cost of experiments and enlarging the scope of applications of air-conditioning system platform functioning as fundamental products.

### A Second Embodiment

As shown in FIG. 2, the second embodiment differs from the first embodiment in that the starting command in this embodiment is a manual activation of a starting switch 5. That is, the pressure in the vehicle is not be regulated automatically after the air-conditioner is initially powered on in each day, but instead the user regularly reads the value of pressure P in the vehicle from the touch screen on the air-conditioner or the HMI display, and activates the process of regulating the angle of the exhaust air valve by manually activating the starting switch 5. The target requirement is the number of manually activating the starting switch 5, i.e., the number of manual regulation, but not the automatic regulation according to the pressure in the compartment.

The starting switch functions as “increase” or “decrease”. The user manually chooses to increase or decrease the angle of the exhaust air valve 3 according to the displayed value of the pressure P in the compartment. Through each manually activated “increase” or “decrease” on the switch the control apparatus controls the exhaust air valve 3 to correspondingly increase or decrease by a set angle. The set angle for each increase or decrease is preferably 1 degree. And a time interval between two adjacent regulations is preferably set as 30 seconds. Even if the “increase” or “decrease” on the switch is constantly pressed, the air-conditioning system controller 2 automatically controls to delay 30 seconds before a next regulation of the angle of the exhaust air valve 3.

The method in this embodiment is described as follows.

In step S21, the pressure P in the compartment is regularly read from the touch screen on the air-conditioner or the HMI display, based on which it is manually determined whether to regulate the angle of the angle of the exhaust air valve 3.

In step S22, a manual press on “increase” or “decrease” button is performed for regulating the angle of the exhaust air valve 3 if it is determined to regulate the angle of the exhaust air valve 3, in which each press regulates the angle of the exhaust air valve 3 by 1 degree. A time interval (30 seconds) is set between two adjacent regulations. A next press triggers a next regulation.

In step S23, the press on the button activates a program for regulating the angle of the exhaust air valve 3 embedded in the air-conditioning system controller 2.

In step S24, the regulated angle of the exhaust air valve 3 is updated and saved into the air-conditioning system controller 2. The air-conditioning system when being powered on again works with reference to the regulated angle.

### A Third Embodiment

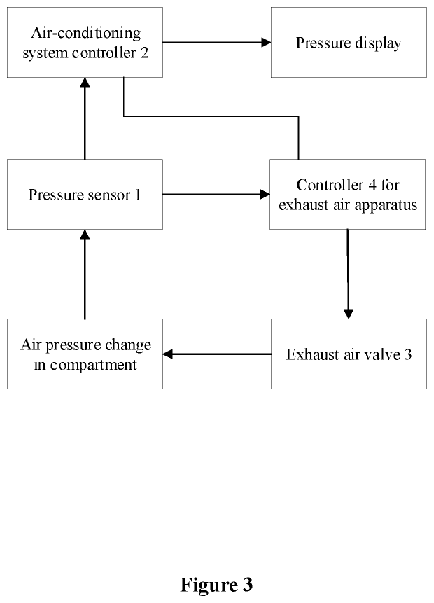

As shown in FIG. 3, this embodiment differs from the first embodiment and the second embodiment in that, in rail vehicles with relative high level of velocity, it is mandatory that the exhaust air valve 3 of the ventilation and exhaust air apparatus uses a structure that has the pressure-driven apparatus for regulating the angle of exhaust air valve. The regulation of the angle of the exhaust air valve 3 is not controlled by the air-conditioning system controller 2. Instead, the fine tuning of the angle of the exhaust air valve 3 is controlled only by a controller 4 for the exhaust air apparatus. The detailed process is described as follows.

The pressure sensor 1 collected data of the pressure in the compartment and send the data to the controller of the exhaust air apparatus and the air-conditioning system controller. The controller 4 for the exhaust air apparatus automatically fine-tunes the angle of the exhaust air valve 3 according to signals from the pressure sensor 1. Being similar to the first embodiment and the second embodiment, the value of the pressure is recorded and displayed by the air-conditioning system controller 2 and the initial angle of the exhaust air valve 3 is controlled by the air-conditioning system controller 2 in order to avoid excessive pressure immediately after the air-conditioner is turned on.

### A Fourth Embodiment

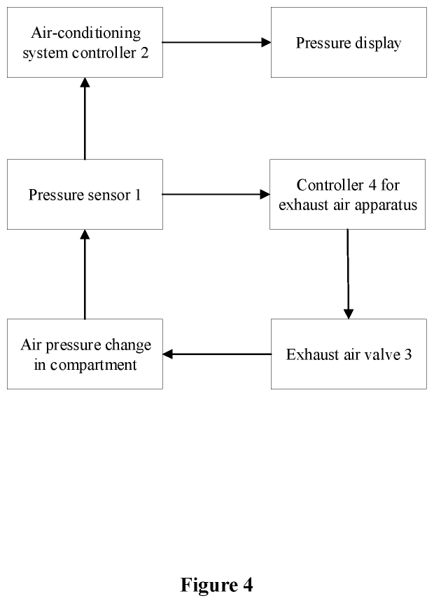

As shown in FIG. 4, this embodiment differs from the third embodiment in that the regulation of the angle of the exhaust air valve 3 is entirely controlled by the controller 4 for the exhaust air apparatus. The controller 4 for the exhaust air apparatus controls the angle of the exhaust air valve 3 according to signals from the pressure sensor 1. After the air-conditioner is initially powered on, the controller 4 for the exhaust air apparatus controls the exhaust air valve 3 to regulate the angle to an initial angle and then regulates to a specific angle according to feedbacks of pressure signals. The initial angle is to avoid excessive pressure immediately after the air-conditioner is turned on.

As illustrated above, some similar technical solutions can be derived from the technical solutions in conjunction with the accompanying drawings. However, any modification, equivalents and revisions without departing from the technical solutions of the present invention shall fall in the scope of the technical solutions of the present disclosure.

1. A method for regulating a pressure in a vehicle, comprising:
In step S1, detecting a pressure P in a compartment of the vehicle; and
In step S2, regulating, by a control apparatus, an angle of an exhaust air valve in response to a starting command, until a target requirement is met.

2. The method for regulating a pressure in a vehicle according to claim 1, wherein the starting command is to instruct the control apparatus to determine whether the pressure P in the compartment exceeds a set pressure range Ps±ΔP, and to automatically regulate the angle of the exhaust air valve in a set logic if the pressure exceeds the set pressure range.

3. The method for regulating a pressure in a vehicle according to claim 2, wherein during each regulation cycle, after an air-conditioning system is initially powered on, the control apparatus automatically determines whether the pressure P in the compartment exceeds the set pressure range Ps±ΔP and automatically regulates the angle of the exhaust air valve.

4. The method for regulating a pressure in a vehicle according to claim 2, further comprising: a manual operation of determining whether the angle regulation should continue if the control apparatus determines that the pressure P in the compartment exceeds the set pressure range Ps±ΔP.

5. The method for regulating a pressure in a vehicle according to claim 2, wherein the set logic is that,
if the detected pressure P in the compartment is higher than the set pressure range Ps+ΔP, the angle of the exhaust air valve is controlled to increase by once or more times control until the target requirement is met; and
if the detected pressure P in the compartment is lower than the set pressure range Ps−ΔP, the angle of the exhaust air valve is controlled to decrease by once or more times control until the target requirement is met;
wherein the target requirement is to regulate the pressure P in the compartment to fall within the set pressure range Ps±ΔP.

6. The method for regulating a pressure in a vehicle according to claim 1, wherein the starting command is to manually activate a starting switch which functioning as “increase” or “decrease”, and the control apparatus controls the exhaust air valve to correspondingly increase or decrease a set angle in response to each manual activation.

7. The method for pressure regulating a pressure in a vehicle according to claim 6, wherein the target requirement is the number of manually activating the starting switch.

8. The method for pressure regulating a pressure in a vehicle according to claim 5, wherein a time interval is set between two adjacent regulations.

9. The method for pressure regulating a pressure in a vehicle according to claim 1, wherein the control apparatus includes an air-conditioning system controller or a controller for an exhaust air apparatus.

10. An apparatus for pressure regulating a pressure in a vehicle for implementing the method for regulating a pressure in a vehicle according to claim 1, comprising:
a pressure detection apparatus, configure to detect in real time a pressure P in a compartment of the vehicle;
a control apparatus, configured to regulate an angle of an exhaust air valve in response to a starting command until a target requirement is met.

11. The method for pressure regulating a pressure in a vehicle according to claim 6, wherein a time interval is set between two adjacent regulations.
